(19) United States
(12) Patent Application Publication
(10) Pub. No.: US 2014/0105231 A1
(43) Pub. Date: Apr. 17, 2014

(54) CONICAL OPTICAL FIBER

(71) Applicant: Kyung Yong Lee, Busan-si (KR)

(72) Inventor: Kyung Yong Lee, Busan-si (KR)

(21) Appl. No.: 13/653,947

(22) Filed: Oct. 17, 2012

(51) Int. Cl. H01S 3/30

(52) U.S. Cl. 372/6

(57) ABSTRACT

A conical shaped-optical fiber is provided. The optical fiber includes remote end that is formed as a conical shape similar to a pointed end of a pencil and thus the laser beams are accumulated on the remote end for cutting tissue similar to a knife end. Further, in order to send laser beams circlewise in a tissue to a side, the remote end of the optical fiber is formed as a conical shape and the angle of the conical shape is adjusted for laser beams not to be accumulated on the remote end but to be scattered.

### BACKGROUND

(a) Technical Field

There are direct and indirect ways for transmitting laser beam wherein the indirect way is performed by using optical fiber as a transmitting medium. Here, in a case of using the optical fiber, most beams are transmitted linearly; however, in case of sending the laser beam toward a side, a reflector has to be mounted on the optical fiber or the optical fiber has to be a conical shape.

In an existing method, the beam is reflected to one side of the optical fiber by using a reflector, or the beam is reflected to an angle of 360° by using 360° reflector. Here, under the same conical shape of the optical fiber, in a case of the remote end of the optical fiber being configured to be long, as shown in FIG. 1, the laser beam is difficult to diffuse to a side and further is accumulated on the remote end. In order for the laser beam to exit to a side the angle of the remote end of the optical fiber has to be configured as shown in FIGS. 2 and 3.

(b) Background Art

Generally, when an optical fiber is used, a reflector is not necessary since the optical fiber is used at a place where light goes straightly ahead. However, the reflector has to be used for the beam to be reflected to a side at a narrow place such as a human body, or the remote end of the optical fiber had to be a conical shape and further the angle of the conical shape may be adjusted for the beam to be diffused to a side.

### SUMMARY OF THE DISCLOSURE

Even though a reflector may be used for laser beam to be sent to a side at an angle of 90°, it is inconvenient and thus the remote end of the optical fiber is configured as a conical shape wherein the laser beam is sent to a side thereof by using a principle that the progress direction of the laser beam is varied depending on an adjustment of the angle of the remote end.

The remote end of the optical fiber is formed as a conical shape by processing and grinding the remote end with ultra-precise processing machine in order to form the remote end of the optical fiber as a conical shape.

When the laser beam is emitted from a side of an optical fiber, it is possible to operate a part of a human body where it is difficult to operate by using the optical fiber through which laser beam emits straightly and thus it is very convenient. Further, constant energy is transferred simultaneously through entire inner part of a tube to make the operation convenient and effective.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein: as shown in the representative drawing, the optical fiber according to the present invention includes a covering and an optical fiber, and the laser beam is emitted at different angles depending on the shapes of the remote end thereof;

FIG. 1 is a view showing an prior optical fiber wherein laser beams emit straightly; and

FIGS. 2 and 3 are views showing the laser beams which emit at an different angle depending on the angle of the conical shape.

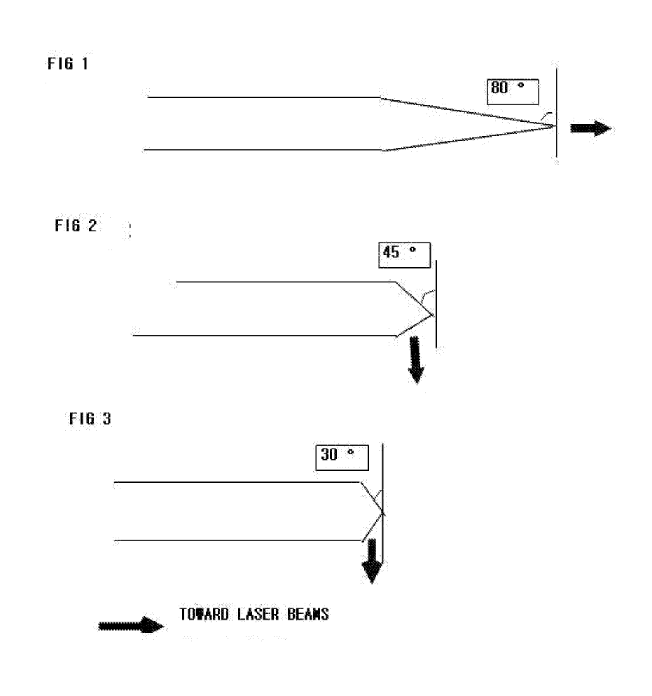

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

According the present invention, the conical shape of an optical fiber is formed by peeling a cover at a remote end and ultra-precise processing the optical fiber by using a special grinder while adjusting the angle of a remote end thereof.

Here, there are several ways for adjusting the angle of the remote end wherein one is to adjust a fixing unit for fixing the optical fiber and another is to adjust the angle of the grinder. Meanwhile, the angle for the laser beams to emit to a side may be various, and it is preferably 25-90° for the laser beam to emit to a side an an angle of 90°.

Further, the laser beams does not necessarily emit at an angle of 90° and thus various angles may be used for the laser beams to emit at various angles. Additionally, the remote end of the optical fiber is covered by a glass tube for protecting the remote end, but it is not limited thereto, proper protecting devices may be used for protecting the remote end without using the glass tube.

The remote end of the conical shaped-optical fiber according to the present invention is shaped as a conical form for emitting laser beams to a side an an angle of 90° wherein the angle of the conical shape may be a range of 1 to 89°. Further, the surface of the conical shape may be grinded or coated specially.

Meanwhile, the optical fiber may be fabricated by using a general material or special material. Further, a diameter of the optical fiber may 0.1-5 mm. At this time, the remote end of the optical fiber may be fabricated by using a general transparent glass tube or pyrex, which has excellent light transmission property and high strength not to be broken easily. A length of the remote end may be 0.1-50 mm.

Furthermore, the protection tube of the optical fiber according to the present invention may be shaped as a circle, an oval, a triangle, or a quadrangle, and the shape of the remote end may be conical shape, a round shape, a concave shape, a triangle shape, or a quadrangle shape. A thickness of the tube may be 0.1-5 mm.

Further, a reflector is used in the glass tube of the optical fiber according to the present invention to prevent a part of the laser beams emitting from the optical fiber from being sent to a side and send the laser beams to a side.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

1. A conical optical fiber, comprising a reflector provided in a glass tube for preventing a part of laser beams emitting from an optical fiber from being sent straightly and sending it to a side, wherein a remote end of the optical fiber is formed as a conical shape for emitting laser beams from a circumferential side of the conical remote end of the optical fiber to an outside at an angle of 90°, wherein an angle of the conical shape is from 1 to 89°.

2. (canceled)

3. The optical fiber of claim 1, wherein a diameter of the optical fiber is from 0.1 to 5 mm; a length of the remote end is from 0.1 to 50 mm; and a thickness of the glass tube is from 0.1 to 5 mm.

4. A conical optical fiber, comprising a reflector provided in a glass tube for preventing a part of laser beams emitting from an optical fiber from being sent straightly and sending it to a side, wherein a remote end of the optical fiber is formed as a conical shape for emitting laser beams from a circumferential side of the conical remote end of the optical fiber to an outside at an angle of 90°, wherein an angle of the conical shape is from 1 to 89°, and wherein the emitted laser beams create a hollow cone defined by inside surfaces of the laser beams and the apex of the conical shape of the remote end is the apex of the hollow cone.

5. The optical fiber of claim 4, wherein a diameter of the optical fiber is from 0.1 to 5 mm; a length of the remote end is from 0.1 to 50 mm; and a thickness of the glass tube is from 0.1 to 5 mm.

6. The optical fiber of claim 4, wherein the angle of the conical remote end is 90°.

7. The optical fiber of claim 4, wherein the angle of the conical remote end is 120°.
